(19) United States
(12) Patent Application Publication
(10) Pub. No.: US 2001/0043008 A1
(43) Pub. Date: Nov. 22, 2001

(54) Replaceable luggage wheel

(75) Inventor: Chung Hsien Kuo, Pan-Chiao City (TW)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Chaw Khong Technology Co., Ltd.

(21) Appl. No.: 09/801,889

(22) Filed: Mar. 8, 2001

(30) Foreign Application Priority Data
May 15, 2000 (TW) 089208121

(51) Int. Cl. B60B 23/00

(52) U.S. Cl. 301/111.05

(57) ABSTRACT

A luggage wheel is secured by threading a screw into a threaded hole at the bottom of the wheel mount until the screw is engaged with the annular groove of the pin, which is inserted into the through hole of the wheel. The luggage wheel is replaced by screwing off the screw, disengaging it from the pin, and then pulling off the pin from the wheel. By using this method, a quick and simple replacement of the damaged wheel is fulfilled.

### BACKGROUND OF THE INVENTION

1. Field of the Invention

The present invention relates to luggage and more particularly to a luggage wheel, which can be replaced from outside whenever the wheel is damaged.

2. Description of Related Art

In the conventional design, as shown in FIG. 4, two wheels E are mounted on the rear bottom of luggage D, and the outer bracket A and the inner bracket B for each of the wheels are secured to luggage D by fastening screws C2 and C1 from outside and inside of the luggage, respectively. However, by using such a design, whenever the situation arises that the wheel E is damaged and needs to be replaced, it is always necessary for the user to unscrew both the fastening screws C2 and C1 from outside and inside of the luggage, respectively. With such a design, especially when the user tries to unfasten the screw C1 from inside the luggage, it causes damage to the interior decoration of the luggage; therefore, such a luggage wheel design is considered undesirable.

A Taiwanese Patent Publication No. 260,906 discloses a replaceable luggage wheel. In this new design, the replacement of the luggage wheel is done simply by removing a pivot pin. The wheel mount is mounted from outside to the luggage body, and the fastening method is to secure the wheel mount to the outer bracket from inside the luggage by using a number of screws. Such a design is also considered undesirable due to the excessive use of fastening components, and the process of replacing the luggage wheels is not simplified.

### SUMMARY OF THE INVENTION

It is therefore the objective of the present invention to provide a luggage wheel, which has the following replacement features. By employing a simple mechanism, a pivot pin is secured to the replaceable luggage wheel by way of a screw which is fastened to the bottom of the wheel mount and which also controls the pin's location. The wheel is replaced by firstly detaching, or loosening, the screw from its original position where the screw and the pin are engaged to a new position where the screw and the pin become separate, and then pulling the pin off the wheel.

In order to achieve the above mentioned and other objectives, the present invention provides a replaceable luggage wheel assembly, which comprises a bracket, a wheel, and a pin assembly. The pin assembly is mounted on the bottom of the bracket; an annular groove is provided near the head of the pin; a threaded hole is disposed on the bottom of the wheel mount, and a screw can be fastened through the threaded hole to pivotally secure the pin to the wheel mount. With such a design, a damaged wheel can be replaced in a quick and simple manner.

The above and other objects, features and advantages of the present invention will become apparent from the following detailed description made in conjunction with the accompanying drawings.

### BRIEF DESCRIPTION OF THE DRAWINGS

FIG. 1 is a plan view with a partial section of a preferred embodiment of the replaceable luggage wheel in accordance with the present invention, wherein the pin is in its separate position from the wheel;

FIG. 2 is similar to FIG. 1 except that the pin is pivotally secured to the wheel;

FIG. 3 is a side view of FIG. 2; and

FIG. 4 is a partially exploded view of the conventional luggage wheel assembly.

### DETAILED DESCRIPTION OF THE PREFERRED EMBODIMENTS

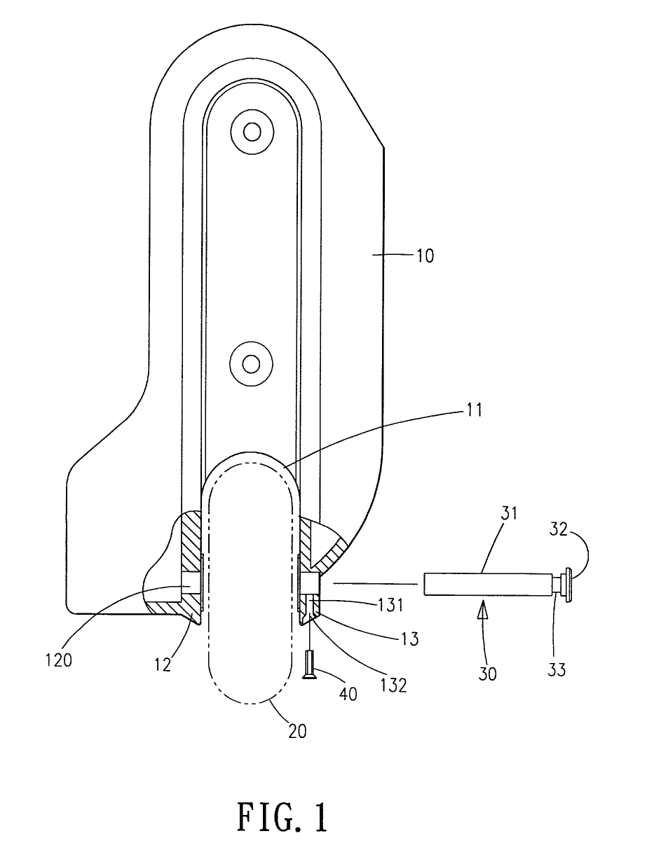

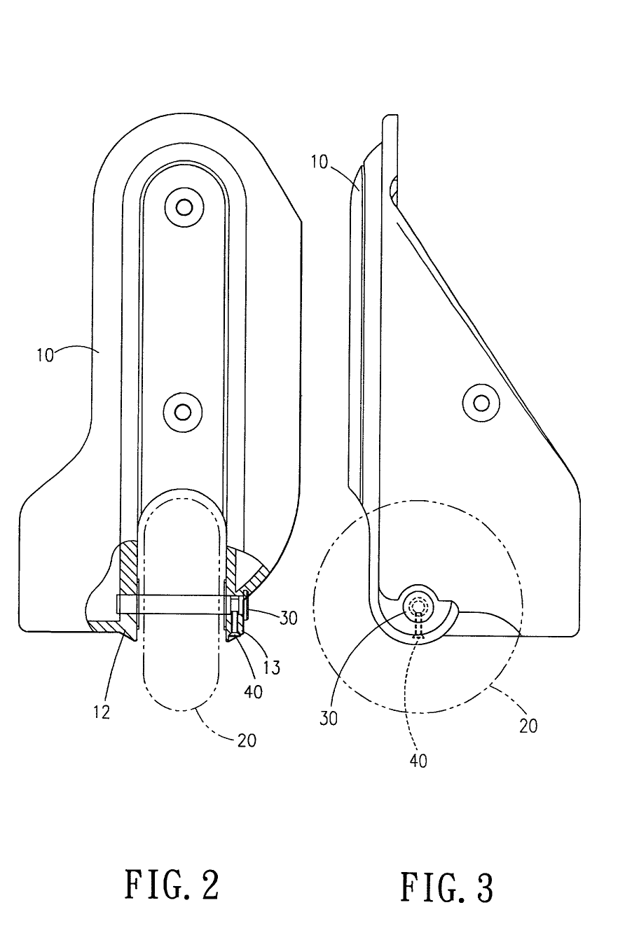

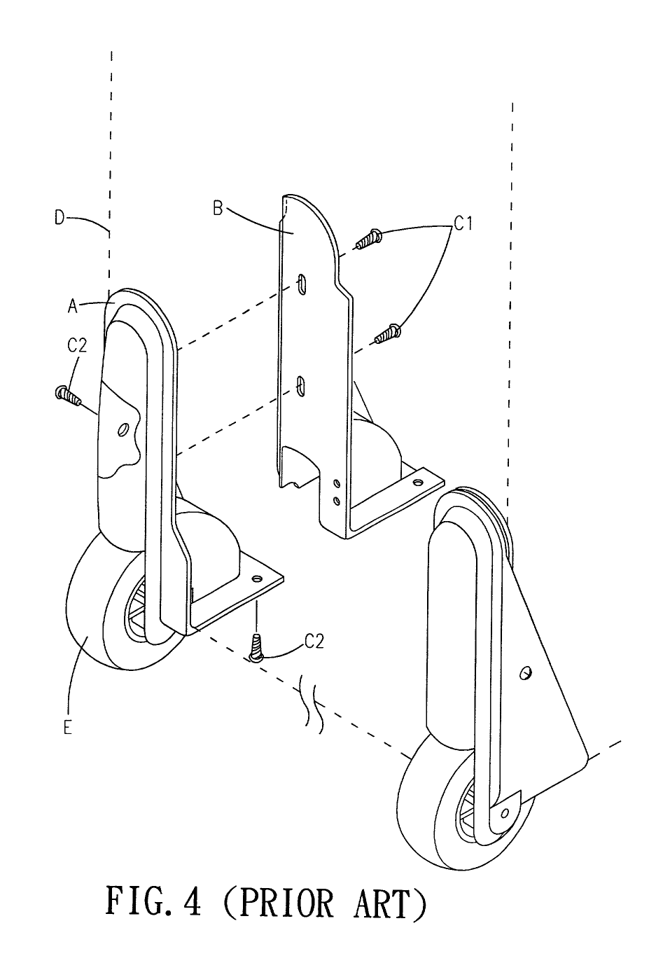

FIGS. 1, 2, and 3 show a replaceable luggage wheel assembly constructed in accordance with the present invention. The wheel assembly comprises a bracket 10, a wheel 20, and a pin 30; wherein both the wheel 20 and the pin 30 are mounted on the bottom of the bracket 10. A well 11 is located at the lower part of the bracket 10; an inner wheel mount 12 and an outer wheel mount 13 are allocated at the two opposite sides of the lower part of well 11; a through hole 120 penetrates the inner and the outer wheel mounts 12 and 13; a threaded hole 131 is drilled at the bottom surface 132 of the outer wheel mount 13, and the threaded hole 131 is in communication with the through hole 120 of the outer wheel mount 13.

Pin 30 comprises a head 32, an annular groove 33 provided near the head 32, and a shank 31. In order to secure the luggage wheel 20 to the bracket 10 through the pin 30, which is inserted into the through hole 120, the annular groove 33 of the pin 30 is aligned with the threaded hole 131 at the bottom surface 132 of the outer wheel mount 13, and then the screw 40 is threaded through the threaded hole 131 to pivotally secure the pin 30 to the wheel 20. Nevertheless, when there is a need to detach the pin 30 from the wheel 20 due to wear or damage to the wheel 20, the user simply replaces the wheel 20 with a new wheel by screwing off the screw 40 on the bottom surface 132 of the outer wheel mount 13 and then pulling off the pin 30 from the wheel 20.

The threaded hole 131 may be replaced by a dent (not shown), and the screw 40 may be replaced by a steel ball and a spring combination (not shown), which are embedded in the dent. In such a manner, the annular groove 33 of the pin is pivotally secured by the steel ball which is elastically biased by the compressed spring when the pin 30 is inserted into the through hole 120 of the wheel 20. When the user needs to replace the wheel, however, all he/she needs to do is to exert a sufficient pulling force on pin 30 to cause it to disengage from the steel ball. In such a manner, the task of replacing the worn-out or damaged luggage wheel can be fulfilled in a quick and simple manner. Also note that the above dent may be replaced by a through-threaded hole such that a short screw may be threaded into the through threaded hole in order to secure the spring into the through-threaded hole.

While the invention herein disclosed has been described by means of specific embodiments, numerous modifications and variations can be made thereto by those skilled in the art without departing from the spirit and scope of the invention set forth in the claims.

What is claimed is:

1. A wheel assembly mounted at the bottom of a luggage comprising:
a bracket;
a wheel;
a pin including a groove and a shank;
a well provided at a lower part of the bracket;
an inner wheel mount and an outer wheel mount both provided at two opposite sides of a lower part of the well;
a horizontal through hole penetrating both the inner and the outer wheel mounts; and
a threaded hole provided at a bottom surface of the outer wheel mount which is also in communication with the horizontal through hole;
wherein when the pin is inserted into the horizontal through hole, the groove of the pin is aligned with the threaded hole so as to thread a screw through the threaded hole to pivotally secure the pin to the wheel.

2. The wheel assembly of claim 1, wherein the groove is annular.

3. The wheel assembly of claim 1, wherein the pin further comprises a head.

4. A wheel assembly mounted at the bottom of a luggage comprising:
a bracket;
a wheel;
a pin including a groove and a shank;
a well provided at a lower part of the bracket;
an inner wheel mount and an outer wheel mount both provided at opposite sides of a lower part of the well;
a horizontal through hole penetrating both the inner and the outer wheel mounts;
a dent provided at the outer wheel mount and also in communication with the horizontal through hole; and
a detent means including a steel ball and a spring embedded in the dent;
wherein when the pin is inserted into the horizontal through hole, the groove of the pin is held by the detent so as to pivotally secure the pin to the wheel by the steel ball which is elastically biased by the compressed spring.

5. The wheel assembly of claim 4, wherein the dent is a through threaded hole such that a screw is further threaded into the through-threaded hole to secure the spring to the through-threaded hole.
